(19) United States
(12) Patent Application Publication
(10) Pub. No.: US 2023/0405690 A1
(43) Pub. Date: Dec. 21, 2023

(54) METHOD AND APPARATUS FOR MOUNTING A FIXTURE TO A VERTICAL SURFACE

(71) Applicant: William G. Nelson, South Haven, MN (US)

(72) Inventor: William G. Nelson, South Haven, MN (US)

(21) Appl. No.: 18/210,164

(22) Filed: Jun. 15, 2023

Related U.S. Application Data
(60) Provisional application No. 63/353,359, filed on Jun. 17, 2022.

(51) Int. Cl. B23B 51/00

(52) U.S. Cl. CPC B23B 51/0054

(57) ABSTRACT

Various examples embodiments are directed to issues such as those addressed above and/or others which may become apparent from the following disclosure concerning the involving the attachment of a fixture to a vertical surface.

### CROSS-REFERENCE TO RELATED APPLICATION(S)

This application claims the benefit of U.S. Provisional Application No. 63/353,359, filed Jun. 17, 2022, and entitled “METHOD AND APPARATUS FOR MOUNTING A FIXTURE TO A VERTICAL SURFACE,” the disclosure of which is hereby incorporated by reference in its entirety.

### BACKGROUND

The present invention is directed to the attachment of fixtures such as picture frames, shelves, and cabinets on to a vertical surface such as a wall for example.

Most homeowners have a need to attach or hang various item to a wall such as picture frames, cabinets, shelving, etc. As such, there are many methods to attach these items to a vertical surface. These may include solutions such as hanger clips, wires and hooks, adhesives, etc. Each of these have issues such as causing damage to walls, or leaving large holes in the wall. Some solutions, such as wire and hooks does not allow for a flush attachment to the vertical surface. Some solutions require the locating of studs for mounting.

### SUMMARY

Various examples embodiments are directed to issues such as those addressed above and/or others which may become apparent from the following disclosure concerning the involving the attachment of a fixture to a vertical surface.

In a more specific example are directed to embodiments in which a pins or headless nails are partially inserted into a fixture and the resulting assembly is then pressed against a vertical surface, delivering the exposed pins into the surface.

In another example holes, to enable pins or headless nails to be inserted into a fixture, are created with the aid of a physical guide. Such a guide is used position a drill bit, reamer, or awl so as to create the hole at an appropriate angle.

### BRIEF DESCRIPTION OF THE DRAWINGS

Various embodiments may be more completely understood in consideration of the following detailed description in connection with the accompanying drawings, in which:

FIG. 1 is a diagram illustrating a fixture and the vertical surface to which it is to be attached in accordance with the present disclosure; and

FIG. 2 is an illustration of a physical guide which may be used to assist in creating a hole in a fixture in accordance with the present disclosure; and

FIG. 3 is a diagram illustrating the use of a physical guide along and a drill bit used to create a hole in a fixture in accordance with the present disclosure; and

FIG. 4 is diagram illustrating the attachment of a fixture, with pins installed, to a vertical surface in accordance with the present disclosure; and

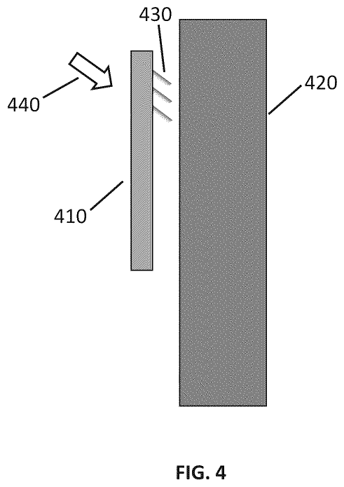

FIG. 5 is diagram illustrating a fixture, with pins installed, attached to a vertical surface in accordance with the present disclosure; and

While various embodiments discussed herein are amenable to modifications and alternative forms, aspects thereof have been shown by way of example in the drawings and will be described in detail. It should be understood, however, that the intention is not to limit the disclosure to the particular embodiments described. On the contrary, the intention is to cover all modifications, equivalents, and alternatives falling within the scope of the disclosure including aspects defined in the claims. In addition, the term “example” as used throughout this application is only by way of illustration, and not limitation.

### DETAILED DESCRIPTION

Aspects of the present disclosure are believed to be applicable of different methods and apparatuses involving the attachment of a fixture to a vertical surface. While the present disclosure is not necessarily limited to such aspects, an understanding of specific examples in the following description may be understood from discussion in such specific contexts.

Accordingly, in the following description various specific details are set forth to describe specific examples presented herein. It should be apparent to one skilled in the art, however, that one or more other examples and/or variations of these examples may be practiced without all the specific details given below. In other instances, well known features have not been described in detail so as not to obscure the description of the examples herein. For ease of illustration, the same connotation and/or reference numerals may be used in different diagrams to refer to the same elements or additional instances of the same element. Also, although aspects and features may in some cases be described in individual figures, it will be appreciated that features from one figure or embodiment can be combined with features of another figure or embodiment even though the combination is not explicitly shown or explicitly described as a combination.

According to specific examples of the instant disclosure, embodiments a directed to or involve the attachment of a fixture to a vertical, or semi-vertical surface. Examples of a fixture may include, but not limited to, picture frames, shelving, cabinets, etc. Fixtures may be constructed of wood, plastic, or other material that may be drilled, reamed, or otherwise allow for a hole of some depth to be formed. A vertical surface may be constructed of drywall, wood, or other material that allows for pins, as described in this disclosure, to be inserted by pressing or tapping on the fixture, containing the pins, while the fixture is held against the vertical surface.

In one specific example, embodiments of the instant disclosure may involve physical guide containing a one or more holes, at an angle relative to the bottom surface. A physical guide may be constructed of steel, brass, or other hardened material capable of withstanding repeated use of a drill bit, reamer, awl, or other device used to form a hole in a fixture. To form holes in a fixture a physical guide may be held against a fixture of interest and a drill bit, reamer, awl, or other device, is passed through one of the holes in the physical guide. Devices such as drill bits may be equipped with a mark or physical stop to allow for the creation of a hole with a defined depth. The depth, and pin length, is defined so as to allow sufficient pin depth into the fixture while allowing for sufficient exposed pin length that is to be installed into the vertical surface.

In another example, embodiments are directed to the insertion of pins or headless nails that are inserted in holes created in the fixture to be installed as described previously. The fixture containing pins may then be installed on the vertical surface by locating the desired position and then pressing the fixture against the vertical surface. With sufficient pressure, the exposed portion of the pins enters the vertical surface thereby attaching the fixture securely.

In yet another example, embodiments are directed to an apparatus involving a kit that may be purchased by users. Such a kit may contain, but not limited to, some or all of the following: 1) a physical guide; 2) a drill bit, ream, awl, or other device capable of making a hole in a typical fixture; 3) one or more pins or headless nails.

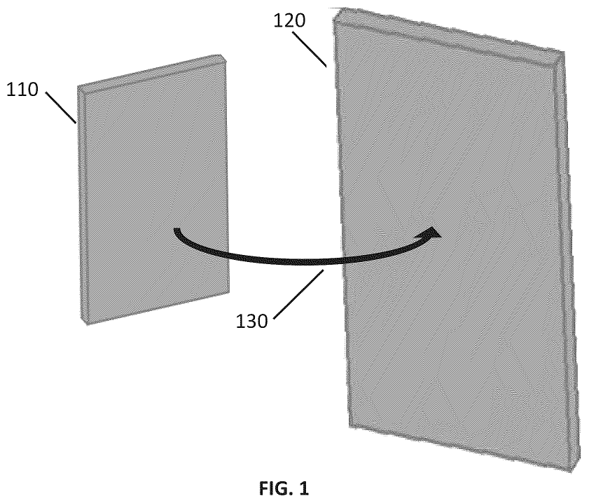

Now turning to the drawings, FIG. 1 illustrates a fixture 110, and a vertical surface 120. 130 illustrates an example of positioning of the fixture on to the vertical surface.

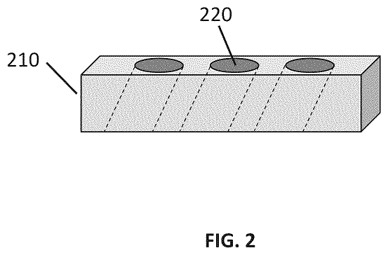

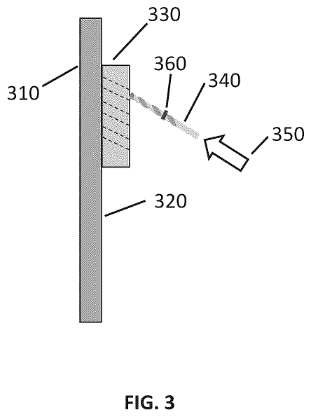

FIG. 2 illustrates an example of a physical guide 210. It may contain one or more holes 220 that are used to guide a hole making device (drill bit, reamer, awl, etc.) at a correct angle into the fixture. The hole(s) 220 may be sized to fit the hole making device with minimal clearance to assist in creating a hole at a correct angle. FIG. 3 illustrates the positioning of the physical guide 330 against the fixture 310. In this example illustration a drill bit 340 is shown entering the physical guide. 350 illustrates the angle to which the drill bit will be inserted to form a hole in the fixture 310. In this example, the drill bit contains a mark or physical stop 350 to allow a user to drill a hole in the fixture 310 at a correct depth.

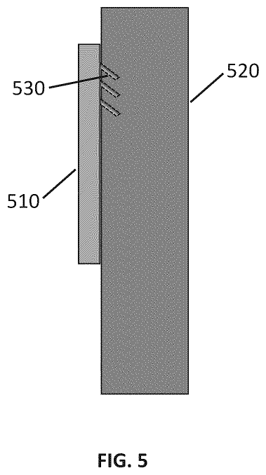

FIG. 3 illustrates positioning of the fixture 410, with inserted pins or headless nails 430, against the vertical surface 420. The figure also shows the downward angle 440 used to press the fixture 410 into the vertical surface 420. Next FIG. 5 illustrates the fixture 510 after pressing against the vertical surface 520. Of note is the pins or headless nails 530 fully engaged into the vertical surface 520 allowing for sufficient strength to support the fixture 510.

A noteworthy characteristic of the present invention is one of the reasons this method is superior to methods currently used. As an example, a current method used to hang a picture on a wall is to drive a nail partially into the wall and simply hang the picture on it. The exposed part of the nail is surrounded by nothing but air, which offers no resistance to bending if the picture is too heavy. The exposed part of the nail is free to move through the air as it bends. The present invention removes this freedom, as part of the nail is imbedded in the wall, and the other part is imbedded in the object being hung. The result is a substantial increase in the amount of weight the nail can support.

The skilled artisan would also recognize various terminology as used in the present disclosure by way of their plain meaning. As examples, it would be appreciated that terms to exemplify orientation, such as upper/lower, left/right, top/bottom and above/below, may be used herein to refer to relative positions of elements as shown in the figures. It should be understood that the terminology is used for notational convenience only and that in actual use the disclosed structures may be oriented different from the orientation shown in the figures. Thus, the terms should not be construed in a limiting manner.

Based upon the above discussion and illustrations, those skilled in the art will readily recognize that various modifications and changes may be made to the various embodiments without strictly following the exemplary embodiments and applications illustrated and described herein. For example, methods as exemplified in the Figures may involve steps carried out in various orders, with one or more aspects of the embodiments herein retained, or may involve fewer or more steps. Such modifications do not depart from the true spirit and scope of various aspects of the disclosure, including aspects set forth in the claims.

1. An apparatus comprising:
components involved in mounting a fixture to a vertical or semi-vertical surface.

2. The apparatus of claim 1, further including at least one of a plurality of pins or headless nails to be inserted into the fixture to be mounted, and with pins or headless nails being inserted into the surface of the fixture adjacent to the vertical surface to which the fixture is being mounted.

3. The apparatus of claim 1, further including a device, such as, but not limited to, a drill bit, reamer, corer, or awl, which may be used in creating a hole or holes, in the fixture to be mounted, to insert the pins or headless nails.

4. The apparatus of claim 3, whereas a drill bit, reamer, corer, or awl, may be equipped this a mark or physical stop so as to assist in creating a hole at a desired depth.

5. The apparatus of claim 1, further including a physical guide used in creating maintaining a desired angle for a drill bit, reamer, corer, or awl, when creating a hole or when pressing, pounding pins or headless nails into the fixture.

6. The apparatus of claim 5, wherein the physical guide may be constructed of various metals, plastics with metal inserts, plastics, or other hardened material which has a flat bottom surface used to press against a fixture, and whereas the guide has a plurality of holes running through the top and bottom of the guide, and whereas the holes are aligned at an angle, and whereas holes have a radius appropriate for the size of the drill bit, reamer, corer, or awl used to create the hole in a fixture.

7. A method comprising:
mounting a fixture to a vertical surface.

8. The method in claim 7, wherein at least one of a plurality of pins or headless nails are inserted into the surface of the fixture adjacent to the vertical surface to which the fixture is being mounted.

9. The method of claim 7, further including creating a hole or holes, in a fixture to be mounted, whereas the pins or headless nails may be inserted into the holes.

10. The method of claim 9, whereas the hole or holes are created using a drill bit, reamer, corer, or awl.

11. The method of claim 9, whereas a hole created by a drill bit, reamer, corer, or awl may be aligned using a physical guide so as to guide the drill bit, reamer, corer, or awl, and further the by drill bit, reamer, corer, or awl may guide the user in creating a correct depth of hole by the inclusion of a mark or stop on the drill bit, reamer, corer, or awl.

12. The method in claim 7, wherein pins or headless nails are inserted into the fixture at an appropriate angle, either using preformed holes or pressing or pounding of the pins or headless nails.

13. The method in claim 7, wherein the fixture, configured with one or more nails or headless nails, may be aligned as desired and then pressed into the vertical or semi-vertical surface.
